(19) United States
(12) Patent Application Publication
(10) Pub. No.: US 2019/0296374 A1
(43) Pub. Date: Sep. 26, 2019

(54) METHODS FOR MANUFACTURING UNIPOLAR AND BIPOLAR PLATES FOR FUEL CELLS

(71) Applicant: GM GLOBAL TECHNOLOGY OPERATIONS LLC, Detroit, MI (US)

(72) Inventors: SIGUANG XU, Rochester Hills, MI (US); LIANG XI, Northville, MI (US); XI YANG, Bloomfield Hills (US)

(21) Appl. No.: 15/926,397

(22) Filed: Mar. 20, 2018

(51) Int. Cl. H01M 8/0297; H01M 8/1004; H01M 8/0267; H01M 8/241; H01M 8/0271

(52) U.S. Cl. CPC H01M 8/0297; H01M 8/1004; H01M 2008/1095; H01M 8/241; H01M 8/0271; H01M 8/0267

(57) ABSTRACT

A method for manufacturing a bipolar plate includes forming two half-plates by stamping a metal substrate to form a plurality of flow channels and a plurality of beads projecting from a first surface of the metal substrate, wherein the plurality of beads include a peripheral bead and one or more aperture beads, each aperture bead being proximate to one or more aperture locations, and wherein each bead has a convex surface and a concave surface, and subsequently compressing the plurality of beads in a die such that the cross-sectional perimeter of each bead is reduced. The half-plates can be joined subsequent to compressing such that at least portions of a second side of the first half-plate are contiguous with at least portions of a second side of the second half-plate, and the one or more aperture locations of each plate align. The beads can be trapezoidal.

### BACKGROUND

Fuel cell systems are increasingly being used as a power source in a wide variety of applications. Fuel cell systems have been proposed for use in power consumers such as vehicles as a replacement for internal combustion engines, for example. Fuel cells may also be used as stationary electric power plants in buildings and residences, as portable power in video cameras, computers, and the like. Typically, the fuel cells generate electricity used to charge batteries or to provide power for an electric motor.

Fuel cells are electrochemical devices which combine a fuel such as hydrogen and an oxidant such as oxygen to produce electricity. The oxygen is typically supplied by an air stream. The hydrogen and oxygen combine to result in the formation of water. Other fuels can be used such as natural gas, methanol, gasoline, and coal-derived synthetic fuels, for example.

The basic process employed by a fuel cell is efficient, substantially pollution-free, quiet, free from moving parts (other than an air compressor, cooling fans, pumps and actuators), and may be constructed to leave only heat and water as by-products. The term “fuel cell” is typically used to refer to either a single cell or a plurality of cells depending upon the context in which it is used. The plurality of cells is typically bundled together and arranged to form a stack with the plurality of cells commonly arranged in electrical series. Since single fuel cells can be assembled into stacks of varying sizes, systems can be designed to produce a desired energy output level providing flexibility of design for different applications.

Different fuel cell types can be provided such as phosphoric acid, alkaline, molten carbonate, solid oxide, and proton exchange membrane (PEM), for example. The basic components of a PEM-type fuel cell are two electrodes separated by a polymer membrane electrolyte. Each electrode is coated on one side with a thin catalyst layer. The electrodes, catalyst, and membrane together form a membrane electrode assembly (MEA).

In a typical PEM-type fuel cell, the MEA is sandwiched between “anode” and “cathode” diffusion mediums (hereinafter “DM's”) or diffusion layers that are formed from a resilient, conductive, and gas permeable material such as carbon fabric or paper. The DM's serve as the primary current collectors for the anode and cathode as well as provide mechanical support for the MEA. The DM's and MEA are pressed between a pair of electronically conductive plates which serve as secondary current collectors for collecting the current from the primary current collectors. The plates conduct current between adjacent cells internally of the stack in the case of bipolar plates and conduct current externally of the stack (in the case of monopolar plates at the end of the stack).

The bipolar plates typically include two thin, facing metal sheets, or half-plates. One of the sheets defines a flow path on one outer surface thereof for delivery of the fuel to the anode of the MEA. An outer surface of the other sheet defines a flow path for the oxidant for delivery to the cathode side of the MEA. When the sheets are joined, the joined surfaces define a flow path for a dielectric cooling fluid. The plates are typically produced from a formable metal that provides suitable strength, electrical conductivity, and corrosion resistance, such as 316L alloy stainless steel for example.

The stack, which can contain more than one hundred plates, is compressed, and the elements held together by bolts through corners of the stack and anchored to frames at the ends of the stack. In order to militate against undesirable leakage of fluids from between the pairs of plates, a seal is often used. The seal is disposed along a peripheral edge of the pairs of plates. Prior art seals have included the use of an elastomeric material in conjunction with a bead stamped into the bipolar plate.

It would be desirable to produce a metal bead seal for sealing between plates of a fuel cell system, wherein the bead structure militates against a leakage of fluids from the fuel cell system and a cost thereof is minimized.

### SUMMARY

A method for manufacturing a half-plate for a fuel cell is provided. The method can include stamping a metal substrate to form at least one bead projecting from a surface of the metal substrate, wherein the metal substrate can have a thickness of less than about 0.2 millimeters and each bead has a convex surface and a concave surface, compressing the at least one bead in a die such that the cross-sectional perimeter of each bead is reduced, and applying a microseal to at least a portion of the convex surface of at least one bead. Each of the convex surface and the concave surface can be at least partially contacted by the die during compression. Subsequent to compressing, a central portion of the convex surface of the bead can be substantially flat. The method can further include trimming the metal substrate, and trimming can occur at the same location and/or time as compressing. The cross-sectional perimeter of each of the at least one beads can be reduced by up to about 8% during compression. The height of each of the at least one beads can be reduced by up to about 50% during compression. The microseal can have a thickness of up to about 0.3 millimeters. The half-plate can include one or more aperture locations, and during stamping at least one bead can be formed proximate to a perimeter of each of the one or more aperture locations.

A method for manufacturing a bipolar plate for a fuel cell is provided. The method includes forming a first half-plate and a second half-plate by stamping a metal substrate to form a plurality of flow channels and a plurality of beads projecting from a first surface of the metal substrate, wherein the plurality of beads include a peripheral bead and one or more aperture beads, each aperture bead being proximate to one or more aperture locations, and wherein each bead has a convex surface and a concave surface, and, subsequent to stamping the plurality of beads, compressing the plurality of beads in a die such that the cross-sectional perimeter of each bead is reduced. The method can further include, prior to, during, or subsequent to forming each respective half-plate, trimming each of the first half-plate and the second half-plate at the respective one or more aperture locations of each plate to form one or more apertures, and, subsequent to compressing each of the first half-plate and the second half-plate, joining the first half-plate and the second half-plate such that at least portions of a second side of the first half-plate are contiguous with at least portions of a second side of the second half-plate, and the one or more aperture locations of the first half-plate align with the one or more aperture locations of the second half-plate. Stamping can further include forming one or more compression limiters, and compressing can further include compressing the one or more compression limiters such that the cross-sectional perimeter of each compression limiter is reduced. The method can further include, subsequent to compressing, applying a microseal to at least a portion of the convex surface of each of the plurality of metal beads. The microseal can include one or more of ethylene propylene diene monomer, hydrogenated acrylonitrile-butadiene, acrylonitrile butadiene, silicone, fluorosilicone, and fluoropolymer. Each of the plurality of beads can have trapezoidal cross-sectional geometry. The height of each of the plurality of beads can be reduced by up to about 50% during compression. The metal substrate can have a thickness of less than about 0.3 millimeters.

A method for manufacturing a bipolar plate for a fuel cell is provided. The method includes forming a first half-plate and a second half-plate by stamping a metal substrate to form at least one bead projecting from a first surface of the metal substrate, wherein each bead has a convex surface and a concave surface, and, subsequent to stamping the plurality of beads, compressing the at least one bead in a die such that the cross-sectional perimeter of each bead is reduced, wherein the convex surface and the concave surface of each bead are at least partially contacted by the die during compression. The method can further include, subsequent to compressing each of the first half-plate and the second half-plate, joining the first half-plate and the second half-plate such that a second side of the first half-plate is contiguous with a second side of the second half-plate. The method can further include, prior to, during, or after forming each respective half-plate, trimming the metal substrate at one or more aperture locations to form one or more apertures. The method can further include, subsequent to compressing, applying a microseal to at least a portion of the convex surface of the at least one bead. The method can further include stamping the metal substrate to form one or more features at the same time as compressing the at least one bead. Each of the convex surface and the concave surface can be at least partially contacted by the die during compression. The cross-sectional perimeter of each of the at least one bead can be reduced by up to about 8% during compression. Joining can including welding.

The present disclosure and its particular features and advantages will become more apparent from the following detailed description of exemplary embodiments and the accompanying drawings.

### BRIEF DESCRIPTION OF THE DRAWINGS

FIG. 1 illustrates an expanded view of a fuel cell stack, according to one or more embodiments;

FIG. 2 illustrates a cross-sectional view of a metal bead seal in a fuel cell, according to one or more embodiments;

FIG. 3 illustrates a plan view of a bipolar plate, according to one or more embodiments;

FIG. 4A illustrates a cross-sectional, partial view of a bipolar plate proximate to a metal bead, according to one or more embodiments;

FIG. 4B illustrates a cross-sectional side view of a half-plate, according to one or more embodiments;

FIG. 5 illustrates a temporal schematic of a method for manufacturing half-plates and bipolar plates, according to one or more embodiments;

FIG. 6A illustrates a schematic cross-sectional side view of a die compressing a metal substrate to form a half-plate, according to one or more embodiments;

FIG. 6B illustrates a cross-sectional side view of a die compressing a metal substrate to form a half-plate, according to one or more embodiments; and

FIG. 6C illustrates a cross-sectional side view of a die compressing a metal substrate to form a half-plate, according to one or more embodiments.

Like reference numerals refer to like parts throughout the description of several views of the drawings.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

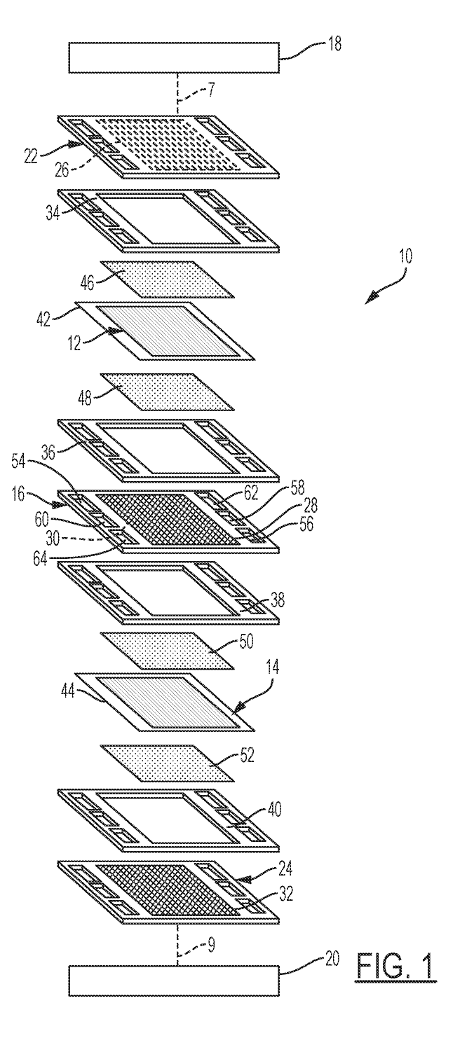

FIG. 1 shows an illustrative bipolar PEM fuel cell stack 10. For simplicity, two-cells in the stack (i.e. three bipolar plates 16, 22, 24) are detailed in FIG. 1, it being understood that a typical stack will have many more such cells and bipolar plates. In some embodiments, unipolar plates are provided at both ends of the fuel cell stack where the unipolar plate includes the flow channels at a cathode side or anode side of the last fuel cell in the stack. While unipolar plates may differ slightly in structure for a given PEM fuel cell stack, reference to bipolar plates herein is intended to include unipolar plates. It is further understood that elements 7 and 9 represent additional optional fuel cells within the fuel cell stack 10. Although a bipolar PEM fuel cell stack is shown, it is understood that other fuel cell types and configurations may also be used without departing from the scope and spirit of the disclosure.

The illustrative fuel cell stack 10 includes a first MEA 12 and a second MEA 14, each having an electrolyte membrane disposed between an anode electrode and a cathode electrode. An electrically conductive bipolar plate 16 is disposed between the first MEA 12 and the second MEA 14. The first MEA 12, the second MEA 14, and the bipolar plate 16 are stacked together between bipolar plates 22, 24 within the fuel cell stack 10. The clamping plates 18, 20 are electrically insulated from the bipolar plates in the stack. For example, a fuel cell stack 10 may have 30-400 plates, or more, as desired.

A working face of each of the bipolar plates 22, 24, as well as both working faces of the bipolar plate 16 include a respective flow field 26, 28, 30, 32 formed therein having a plurality of flow channels. The flow fields 26, 28, 30, 32 distribute reactants such as hydrogen and oxygen/air over the faces of the MEAs 12, 14. For example, a given bipolar plate may have about 10-50 flow channels, or more as desired.

Nonconductive gaskets 34, 36, 38, 40 may be respectively disposed between the bipolar plate 22 and the first MEA 12, the first MEA 12 and the bipolar plate 16, the bipolar plate 16 and the second MEA 14, and the second MEA 14 and the bipolar plate 24. The gaskets 34, 36, 38, 40 facilitate a seal and electrically insulate the end plate 22 and the first MEA 12, the first MEA 12 and the bipolar plate 16, the bipolar plate 16 and the second MEA 14, and the second MEA 14 and the bipolar plate 24.

The MEAs 12, 14 of the illustrative fuel cell stack 10 may have nonconductive subgaskets or barrier films 42, 44. The subgaskets 42, 44, either alone or employed in conjunction with the gaskets 34, 36, 38, 40, extend from the edges of the electrodes and facilitate a seal of the first MEA 12 and the bipolar plate 16 and the bipolar plate 16 and the second MEA 14. The subgaskets 42, 44 also electrically insulate the first MEA 12 and the bipolar plate 16, and the bipolar plate 16 and the second MEA 14. As a non-limiting example, the subgaskets 42, 44 may be formed respectively integral with the nonconductive gaskets 34, 36, 38, 40. The subgaskets 42, 44 may also be formed integrally with the electrolyte membrane. In other embodiments, the subgaskets 42, 44 are formed from another suitable, electrically nonconductive material and coupled to the MEAs 12, 14, respectively. Collectively, the MEAs 12, 14, the gaskets 34, 36, 38, 40, and the subgaskets 42, 44 are known as fuel cell “softgoods” or “softgood layers.”

Gas-permeable DM 46, 48, 50, 52 abut respective electrodes of the first MEA 12 and the second MEA 14. The DM 46, 48, 50, 52 are respectively disposed between the end plate 22 and the first MEA 12, the first MEA 12 and the bipolar plate 16, the bipolar plate 16 and the second MEA 14, and the second MEA 14 and the bipolar plate 24.

The bipolar plates 16, 22, 24, and the gaskets 34, 36, 38, 40 each include a plurality of apertures, including a cathode supply aperture 54 and a cathode exhaust aperture 56, a coolant supply aperture 58 and a coolant exhaust aperture 60, and an anode supply aperture 62 and an anode exhaust aperture 64. Each of the foregoing apertures can represent one or a plurality of apertures; for example, the cathode supply aperture 54 and/or the anode supply aperture can represent two apertures, in some embodiments. The number of apertures relating to cathode, anode, and coolant may vary based on design constraints and/or objectives, as will be known by one of skill in the art. Supply manifolds and exhaust manifolds of the fuel cell stack 10 are formed by an alignment of the respective apertures 54, 56, 58, 60, 62, 64 in the bipolar plates 16, 22, 24, and the gaskets 34, 36, 38, 40. The hydrogen gas is supplied to an anode supply manifold via an anode inlet conduit (not shown). The air is supplied to a cathode supply manifold of the fuel cell stack 10 via a cathode inlet conduit (not shown) at end plate 18. An anode outlet conduit and a cathode outlet conduit are also provided for an anode exhaust manifold and a cathode exhaust manifold, respectively. A coolant inlet conduit (not shown) is also provided at end plate 18 for supplying liquid coolant to a coolant supply manifold. A coolant outlet conduit (not shown) may also be provided at end plate 18 for removing coolant from a coolant exhaust manifold.

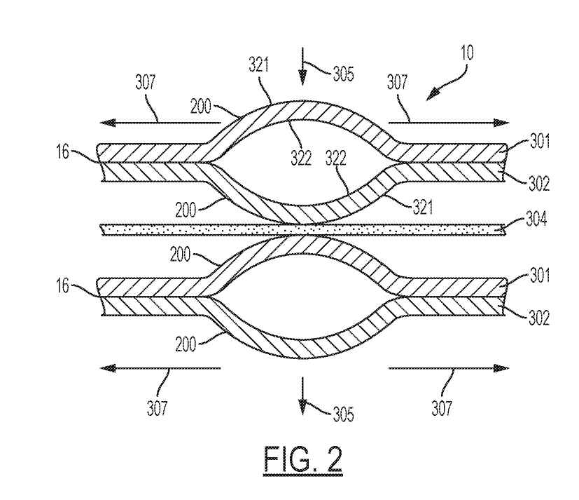

With reference to FIG. 2, each of the pair of traditional bipolar plates 16, 22, 24 is formed from a first half-plate 301 and a second half-plate 302, wherein each half-plate has a first side 321 and a second side 322. The first half-plate 301 is joined to the second half-plate 302 such that the second sides 322 of each half-plate are contiguous. The joined first and second half-plates 301, 302 form internal channels (not shown) adjacent the flow field 28, 30 (FIG. 1) of each of the pair of bipolar plates 16 for coolant to flow therethrough for temperature regulation of the illustrative fuel cell stack 10. The first and second half-plates 301, 302 may be joined by at least one of a variety of suitable means known in the art, such as by welding or by an application of an adhesive, for example. Other suitable means for joining the first half-plate 301 with the second half-plate 302 may be selected as desired.

The bipolar plates 16, 22, 24 of the traditional fuel cell stack 10 have a softer layer 304 such as at least one of the gaskets 34, 36, 38, 40 and the subgaskets 42, 44, for example, disposed between each bipolar plate 16, 22, 24. The single bead 200 is formed on each of the pair of bipolar plates 16, 22, 24. The single bead 200 has a substantially arcuate surface as shown in FIG. 2, although other geometric configurations are practicable. As a non-limiting example, the single bead 200 may be formed by a stamping operation performed on the first and second half-plates 301, 302. The single beads 200 of each of the pair of bipolar plates 16 sandwich the softer layer 304 when the fuel cell stack 10 is placed in the compressed state. In the compressed state, contact between the single beads 200 results.

However, as compression loads 305 (FIG. 2) are applied to the single beads of the fuel cell, the beads have a tendency to flatten given both the top and bottom plates move laterally along the lateral direction 307 as shown in FIG. 2 as the bead absorbs energy from the compression loads 305. The flattening deformation in the traditional bead of FIG. 2 may therefore compromise the fluid tight seal between two bipolar plates.

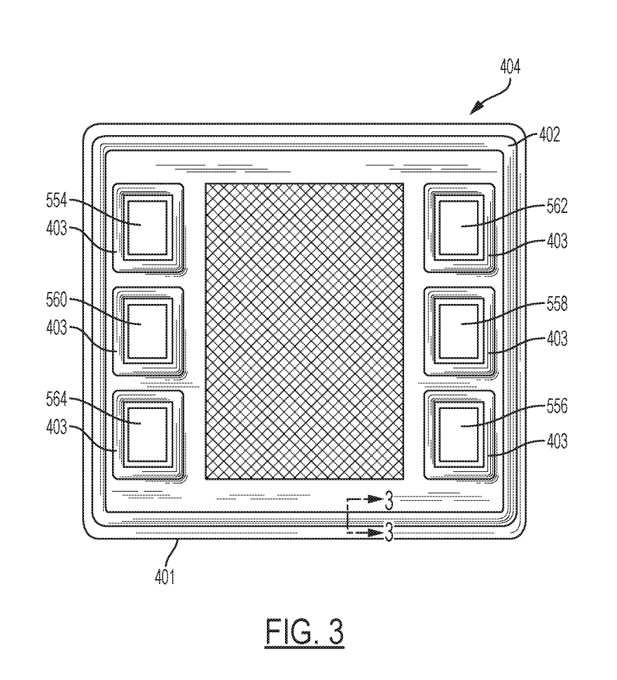

An example bipolar plate 404 of the present disclosure is shown in FIG. 3 in further detail. The bipolar plate 404 includes a plurality of metal bead seals formed thereon, including a peripheral metal bead seal, and a plurality of aperture metal bead seals 403. The peripheral metal bead seal 402 is typically formed on the bipolar plate 404 adjacent or proximate to the peripheral or outer edge 401 (FIG. 3) thereof. The plurality of aperture metal bead seals 403 are each disposed proximate or adjacent to a respective aperture location. Each aperture of bipolar plate 404 (e.g., 554, 556, 558, 560, 562, 564) occurs at a unique corresponding aperture location.

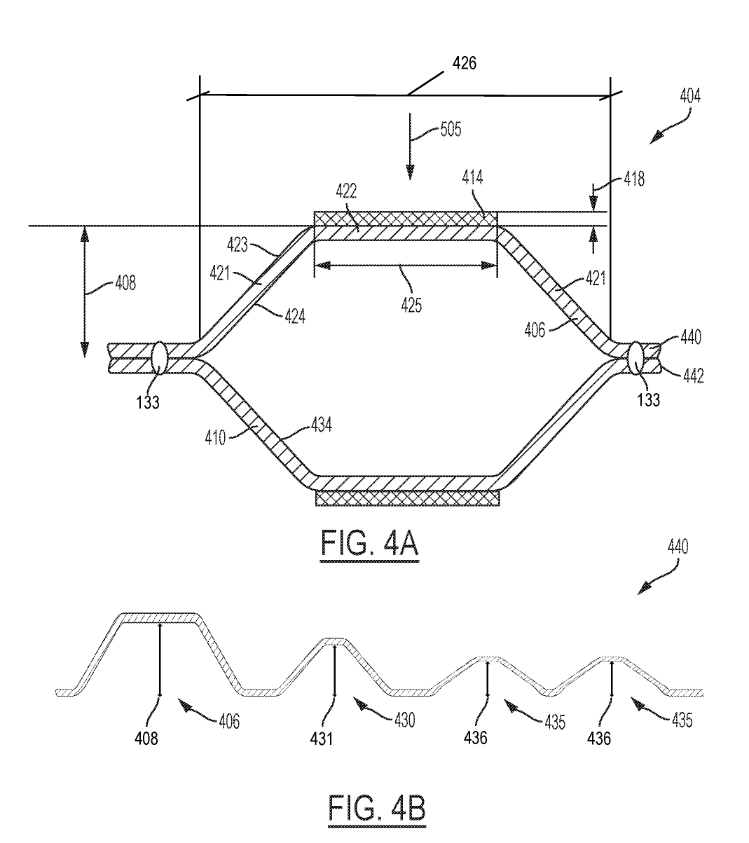

Each metal bead seal comprises two metal beads from two half-plates. FIG. 4A illustrates a bipolar plate 404 comprising a first half-plate 440 comprising a bead 406 and a second half-plate 442 comprising a bead 410, which generally form a metal bead seal. Bead 406 and 410 are shown as generally symmetrical, but asymmetric beads are within the scope of this disclosure. Further, bead 406 and 410 are illustrated as trapezoidal beads. As used herein, “trapezoidal” refers to a bead with two angled walls 421 connecting to a central top portion. As shown in FIG. 4A, the central top portion 422 is shown as substantially flat, but trapezoidal beads may also include central top portions which are concave or convex (e.g., curved concave or curved convex portions). The metal beads described herein may be of varying geometries not limited to those described in FIGS. 2, and 4A-B. In a particular embodiment, each half-plate, described in relation to half-plate 440, comprises a bead 406 defined by a substantially flat portion 422 and two side walls 421, which collectively protrude from the half-plate 440 and define a first, convex side 423 and a second, concave side 424 of the bead 406. In other embodiments, flat portion 422 can be convex or concave, as desired. The flat portion 422 is proximate a central portion of the bead 406 at which the height 408 of the bead is maximum. The flat portion 422 can have a length 425, which is generally not greater than the length 426 of the bead 406. FIG. 4B illustrates a cross-sectional side view of a portion of the half-plate 440 comprising bead 406, a compression limiter 430, and two flow channels 435. A half-plate, such as half-plate 440, may have more or less beads 406, compression limiters 430, and flow channels 435 as desired. The compression limiter 430 has a height 431 which is less than the bead height 408 and greater than the height of the flow channels 436. In some embodiments, a plurality of flow channels 435 may have varying heights, but all such heights will be less than compression limiter height 431.

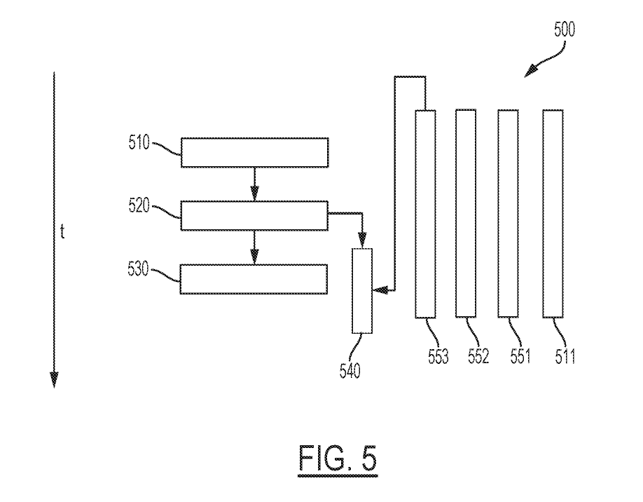

The bipolar plate 404, and all others described herein, can be manufactured to better withstand compressive loads 505 which can occur from the same or other directions as indicated by the arrow. A method 500 for manufacturing half-plates and bipolar plates is illustrated as a temporal schematic in FIG. 5, and comprises stamping 510 a metal substrate, compressing 520 the stamped 510 substrate, and subsequently applying a microseal 530 to the stamped 510 and compressed 510 metal substrate in order to generally form a half-plate, or a first half-plate (e.g., an anode) and a second half-plate (e.g., a cathode). The first half-plate and second half-plate may be symmetrical, or asymmetrical, in various embodiments. Elements within FIG. 5 are disposed to illustrate their possible occurrences with respect to time t, and arrows are used to impose order between certain elements. As illustrated in FIG. 5, an order is imposed between stamping 510, compressing 520, and applying a microseal 530.

A bipolar plate is formed by joining 540 two half-plates. Joining 540 can occur after compressing 520, and before or after applying a microseal 530. Various trimming operations may be performed. Trimming one or more apertures 551 (e.g., trimming apertures 554, 556, 558, 560, 562, and/or 564 at respective aperture locations) can occur any time before stamping 510 through after applying a microseal 530. Trimming a perimeter 552 of the substrate/half-plate/bipolar plate (e.g., trimming outer edge 401 of bipolar plate 404) can occur any time before stamping 510 through after applying a microseal 530. Trimming the substrate/half-plate from a substrate stock 553 can occur any time before stamping 510 through after applying a microseal 530, but generally must occur prior to joining 540. Trimming from a substrate stock 553 can be considered a subset of trimming a perimeter, and can occur at the same time or at different times, per the above constraints. The substrate stock may be a bulk piece of metal, such as supplied in a roll or coil, for example. Advantageously, one or more trimming steps (e.g., trimming 551, trimming 552, and/or trimming 553) may be performed simultaneously during compression 520. Accordingly, the costs, time, and complexity of manufacturing can be reduced.

Because the bipolar plate operates in a high temperature and corrosive environment, conventional metals, such as plain carbon steel, may not be suitable for certain applications (such as in automotive environments) where long life (for example, about 15 years with 10,000 hours of life) is required. During typical PEM fuel cell stack operation, the proton exchange membranes can be at a temperature in the range of between about 75° C. and about 175° C., and at a pressure in the range of between about 100 kPa and 200 kPa absolute. Under such conditions, plates made from alloyed metals such as stainless steel may be advantageous, as they have desirable corrosion-resistant properties. In situations where cost of fuel cell manufacture is an important consideration, metal-based bipolar plates may be preferable to other high-temperature, electrically conductive materials, such as graphite. Prior to stamping 510, the metal substrate may be coated. The metal substrate is generally much thinner than traditional stamping substrates, and can have thicknesses from about 0.075 mm to about 0.1 mm, about 0.05 mm to about 0.15 mm, about 0.05 mm to about 0.2 mm, or about 0.04 mm to about 0.25 mm. The metal substrate can have a thickness of less than about 0.25 mm, less than about 0.2 mm, less than about 0.15 mm, or less than about 0.1 mm, for example. In a particular example, the substrate comprises a thickness of about 0.075 mm to about 0.1 mm.

Stamping 510 comprises stamping one or more features which will be subsequently subjected to compressing 520. For example, stamping 510 can comprise stamping a metal substrate to form at least one bead projecting from a surface of the metal substrate. The bead generally defines a first, convex side and a second, concave side of the bead, such as described in FIGS. 2 and 4. Stamping 510 can further form one or more compression limiters (e.g., compression limiter 430 of FIG. 4B), a plurality of flow channels (e.g., one or more flow channels 435 of FIG. 4B), a peripheral bead (e.g., a peripheral bead of metal bead seal 402 of FIG. 3), a plurality of aperture beads (e.g., one or more aperture beads of metal bead seals 403 of FIG. 3), and/or one or more compression limiters (e.g., compression limiter 430 of FIG. 4B), for example. Stamping 510 may occur in one step and/or die, or in a plurality of steps and/or dies, for example. Subsequent to stamping 510, each formed bead will have a cross-sectional perimeter. For example, the cross-sectional perimeter of the metal bead from FIG. 4A is the sum of the lengths of the two side walls 421, length 425 of flat portion 422, and length 426. In an additional step, stamping 511 may further form features which are not subject to compressing 520, and therefore greater temporal opportunity is afforded relative to stamping 510 (i.e., stamping 511 may occur before, during, or after stamping 510, and may occur before, during, or after compressing 520). For example, stamping 511 may form a plurality of flow channels (e.g., one or more flow channels 435 of FIG. 4B), a peripheral bead (e.g., a peripheral bead of metal bead seal 402 of FIG. 3), a plurality of aperture beads (e.g., one or more aperture beads of metal bead seals 403 of FIG. 3), one or more compression limiters (e.g., compression limiter 430 of FIG. 4B), such as those not subsequently subject to compressing 520, and/or various other stamped features. Stamping 511 can represent one or a plurality of stamping steps that may occur at the same or different times.

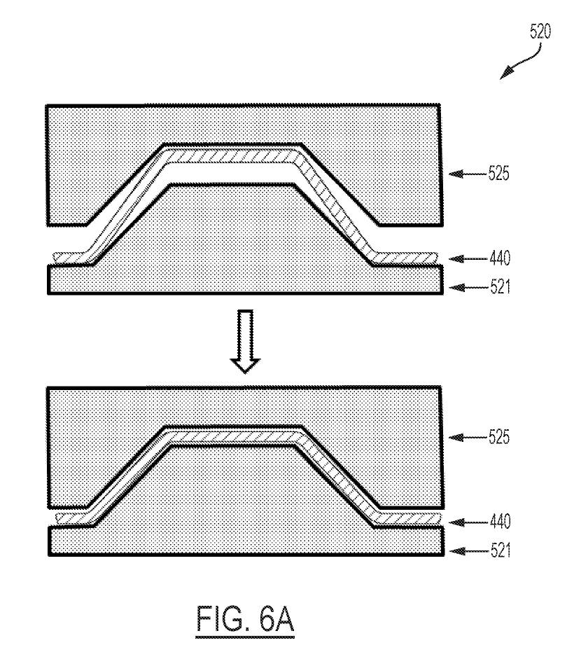

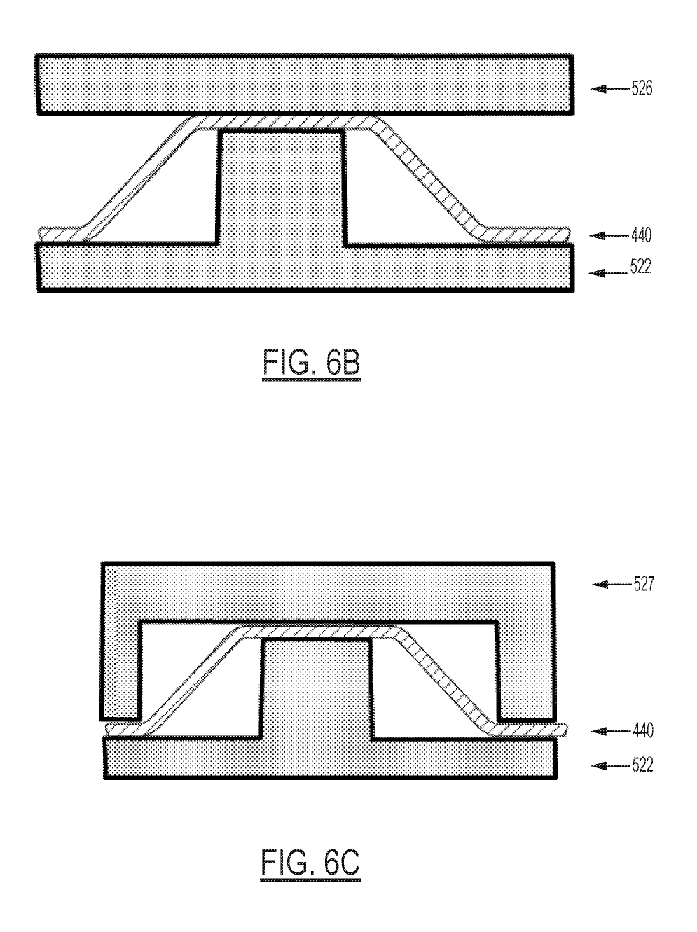

Compressing 520 comprises compressing the one or more metal beads formed during stamping in a die such that the cross-sectional perimeter of each bead is reduced. A central portion of the convex surface of the bead can be substantially flat, convex, or concave after compressing 520. Compressing 520 beads can additionally or alternatively comprise compressing one or more compression limiters (e.g., compression limiter 430 of FIG. 4B) such that a cross-sectional perimeter of each of the one or more compression limiters is reduced. Compression limiters may have varying geometries as desired. FIG. 6A illustrates a schematic view of a die compressing 520 a metal substrate to form a half-plate 440. The die comprises a punch 521 and a block 525. The contours of the punch 521 and block 525 will conform to the desired shape of a compressed 520 bead. The block 525 comprises an inner contour which contacts the convex side of the bead and has some dimensions which are smaller than the convex side of the bead prior to compression 520. For example, as shown in FIG. 6A, the height of the bead is greater than the depth of the block 525 such that during compression 520 the bead is plastically deformed and reduced in at least one dimension causing stress loading and/or strengthening of the bead. Accordingly, subsequent to compressing 520, each metal bead exhibits higher strength and resistance to buckling loads, and similarly, elastic behavior in response to loads is also increased. The die may accommodate one or a plurality of beads, and/or a plurality of separate dies may be utilized to compress a plurality of beads of a particular half-plate.

As shown, the punch 521 and block 525 substantially conform to the concave and convex sides, respectively, of the half-plate 440, and portions of the metal substrate which extend beyond the bead, such that the bead may be compressed without buckling or cracking. Other die configurations may be utilized such that each of the convex surface and the concave surface of the bead are at least partially contacted by the die block and punch, respectively. FIGS. 6B-C illustrate other suitable dies which comport with the methods herein. FIG. 6B illustrates a block 526 which generally contacts a top portion of the convex side of the bead but not the side walls of the bead or portions of the metal substrate which extend beyond the bead, and a punch 522 which generally contacts a top portion of the concave side of the bead, and portions of the metal substrate of the same side which extend beyond the bead, but not the side walls of the bead. FIG. 6C illustrates a block 527 which generally contacts a top portion of the convex side of the bead and portions of the metal substrate which extend beyond the bead but not the side walls of the bead, and the punch 522 described in FIG. 6B. The punch 521 and block 525 of FIG. 6A may be similarly utilized with the blocks 526, 527 and punch 522 of FIGS. 6B-C. Other various configurations and geometries are similarly within the scope of this disclosure. For example, in some embodiments, the top portion of the bead may be rounded and convex prior to compression 520, and may be generally flattened during and subsequent to compression 520. Similarly, in some embodiments, the top portion of the bead may be rounded and convex prior to compression 520, and may be compressed 520 such that the bead height is reduced, but the top portion of the bead is rounded and convex.

The die geometry used for compression 520, the incoming geometry of the substrate prior to compression 520, and the compression time may all be tuned to achieve a compressed 520 half-plate of a desired geometry with desired physical characteristics (e.g., strength, stress loading, etc.) Compression 520 can be momentary, or last up to 30 minutes. Bead buckling load and bead stiffness can be determined by the geometry of the bead, for example. Strain hardening of the bead can relate to dimensional changes of the bead, including changes in bead height, that occur as a result of compression 520. Compression 520 can reduce the cross-sectional perimeter of a bead by up to about 5%, up to about 6%, or up to about 8%. The amount of compression 520 (i.e., the change in cross-sectional perimeter of the bead) depends on the type and thickness of the metal substrate, the dimensions of the metal bead, and the desired physical characteristics of the final compressed 520 bead. For a bead 406 having a trapezoidal geometry subsequent to compression 520, the bead height 408, the flat portion 422 425, or the bead 406 length 426, or combinations thereof, may each be reduced by about 20% to about 50% during compression 520. For a bead 406 having a trapezoidal geometry subsequent to compression 520, the bead height 408, the flat portion 422 425, or the bead 406 length 426, or combinations thereof, may each be reduced by up to about 20%, up to about 35%, or up to about 50% during compression 520.

Applying a microseal 530 comprises applying a microseal to at least a portion of the convex surface of the bead. A microseal 414 is shown in FIG. 4A as applied to half-plate 440. In embodiments wherein the half-plate 440 comprises a flat top portion, the microseal 414 may cover all or a portion of the length 425 of the top portion. Generally, the microseal 414 will be disposed on portion of a bead proximate the maximum height of the bead. In a cooperative metal bead seal relationship between two bipolar plates (e.g., bipolar plates 16 in fuel cell stack 10 of FIG. 2), a microseal of adjacent half-plates of each of the two bipolar plates may cooperatively contact a gasket (e.g., softer layer 304 of FIG. 2). The microseal may comprise a thickness (e.g., thickness 418 as shown in FIG. 4A) of about 0.01 mm to about 0.3 mm, about 0.02 to about 0.2 mm, or about 0.03 to about 0.15 mm. The microseal may comprise a thickness of up to about 0.3 mm, up to about 0.2 mm, or up to about 0.1 mm. The microseal may comprise an elastometric material. Suitable elastomeric materials can comprise one or more of EPDM (Ethylene propylene diene monomer), HNBR (Hydrogenated acrylonitrile-butadiene), NBR (acrylonitrile butadiene), VMQ (silicone), FVMQ (fluorosilicone), and FKM (fluoropolymer), among others. The microseal can be applied via screen printing, for example.

Joining 540 can comprise joining two half-plates (e.g., half-plates 440, 442) such that at least portions of a second side of the first half-plate (e.g., second side 424 of half-plate 440) is contiguous with a second side of the second half-plate (e.g., second side 434 of half-plate 442), and the one or more aperture locations of the first half-plate align with the one or more aperture locations of the second half-plate. The contiguous portions of each half-plate generally correspond to portions without stamped features, such as beads, flow channels, or compression limiters. Joining can be accomplished by welding, application of adhesive, or other suitable means. FIG. 4A illustrates half-plates 440 and 442 joined by two welds 133, for example.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for manufacturing a half-plate for a fuel cell, the method comprising:
stamping a metal substrate to form at least one bead projecting from a surface of the metal substrate, wherein the metal substrate comprises a thickness of less than about 0.2 millimeters and each bead has a convex surface and a concave surface;
compressing the at least one bead in a die such that the cross-sectional perimeter of each bead is reduced; and
applying a microseal to at least a portion of the convex surface of at least one bead.

2. The method of claim 1, wherein each of the convex surface and the concave surface are at least partially contacted by the die during compression.

3. The method of claim 1, wherein subsequent to compressing, a central portion of the convex surface of the bead is substantially flat, convex, or concave.

4. The method of claim 1, further comprising trimming the metal substrate, and trimming occurs at the same location and/or time as compressing.

5. The method of claim 1, wherein the cross-sectional perimeter of each of the at least one beads is reduced by up to about 8% during compression.

6. The method of claim 1, wherein the height of each of the at least one beads is reduced by up to about 50% during compression.

7. The method of claim 1, wherein the microseal comprises a thickness of up to about 0.3 millimeters.

8. The method of claim 1, wherein the half-plate comprises one or more aperture locations, and during stamping at least one bead is formed proximate to a perimeter of each of the one or more aperture locations.

9. A method for manufacturing a bipolar plate for a fuel cell, the method comprising:
forming a first half-plate and a second half-plate by:
stamping a metal substrate to form a plurality of flow channels and a plurality of beads projecting from a first surface of the metal substrate, wherein the plurality of beads include a peripheral bead and one or more aperture beads, each aperture bead being proximate to one or more aperture locations, and wherein each bead has a convex surface and a concave surface; and
subsequent to stamping the plurality of beads, compressing the plurality of beads in a die such that the cross-sectional perimeter of each bead is reduced;
prior to, during, or after forming each respective half-plate, trimming each of the first half-plate and the second half-plate at the respective one or more aperture locations of each plate to form one or more apertures; and
subsequent to compressing each of the first half-plate and the second half-plate, joining the first half-plate and the second half-plate such that at least portions of a second side of the first half-plate are contiguous with at least portions of a second side of the second half-plate, and the one or more aperture locations of the first half-plate align with the one or more aperture locations of the second half-plate.

10. The method of claim 9, wherein stamping further comprises forming one or more compression limiters, and wherein compressing further comprises compressing the one or more compression limiters such that the cross-sectional perimeter of each compression limiter is reduced.

11. The method of claim 9, further comprising, subsequent to compressing, applying a microseal to at least a portion of the convex surface of each of the plurality of metal beads.

12. The method of claim 11, wherein the microseal comprises one or more of ethylene propylene diene monomer, hydrogenated acrylonitrile-butadiene, acrylonitrile butadiene, silicone, fluorosilicone, and fluoropolymer.

13. The method of claim 9, wherein each of the plurality of beads comprises a trapezoidal cross-sectional geometry.

14. The method of claim 9, wherein the height of each of the plurality of beads is reduced by up to about 50% during compression.

15. The method of claim 9, wherein the metal substrate comprises a thickness of less than about 0.3 millimeters.

16. A method for manufacturing a bipolar plate for a fuel cell, the method comprising:
forming a first half-plate and a second half-plate by:
stamping a metal substrate to form at least one bead projecting from a first surface of the metal substrate, wherein each bead has a convex surface and a concave surface;
subsequent to stamping the plurality of beads, compressing the at least one bead in a die such that the cross-sectional perimeter of each bead is reduced, wherein the convex surface and the concave surface of each bead are at least partially contacted by the die during compression;
subsequent to compressing each of the first half-plate and the second half-plate, joining the first half-plate and the second half-plate such that a second side of the first half-plate is contiguous with a second side of the second half-plate prior to, during, or after forming each respective half-plate, trimming the metal substrate at one or more aperture locations to form one or more apertures; and
subsequent to compressing, applying a microseal to at least a portion of the convex surface of the at least one bead.

17. The method of claim 16, further comprising stamping the metal substrate to form one or more features at the same time as compressing the at least one bead.

18. The method of claim 16, wherein each of the convex surface and the concave surface are at least partially contacted by the die during compression.

19. The method of claim 16, wherein the cross-sectional perimeter of each of the at least one bead is reduced by up to about 8% during compression.

20. The method of claim 16, wherein joining comprises welding.
